(19) United States
(12) Patent Application Publication
(10) Pub. No.: US 2025/0109754 A1
(43) Pub. Date: Apr. 3, 2025

(54) ACCUMULATOR WITH LEAKAGE-BASED FILTERING

(71) Applicant: Neptune Technology Group Inc., Tallassee, AL (US)

(72) Inventor: Benjamin Jeffrey Deal Williams, Wetumpka, AL (US)

(21) Appl. No.: 18/797,704

(22) Filed: Aug. 8, 2024

Related U.S. Application Data
(60) Provisional application No. 63/586,106, filed on Sep. 28, 2023.

(51) Int. Cl. F15B 1/24; F15B 1/02

(52) U.S. Cl. CPC F15B 1/24; F15B 1/021

(57) ABSTRACT

A apparatus and a method are described in which the apparatus includes a spring-loaded piston that is configured to move within a passageway. A gap may be formed between the piston and the passageway that enables a resource to leak past the piston. The gap may be configured to enable an amount of leakage of the resource that may filter a frequency or frequency band that may be generated by the operation of the apparatus. The frequency or the frequency band may relate to noise or a sampling rate of a water meter.

### CROSS-REFERENCE TO RELATED APPLICATION

This patent application claims priority under 35 U.S.C. § 119, based on U.S. Provisional Application No. 63/586,106, filed Sep. 28, 2023, the disclosure of which is hereby incorporated by reference herein.

### BACKGROUND

An accumulator is an energy storage device. For example, the accumulator may receive energy, store the energy, and then release the energy as needed. The accumulator may be implemented in different ways including use of a diaphragm, a spring and piston, and other configurations. One application of the accumulator is its use in a hydraulic circuit.

### BRIEF DESCRIPTION OF THE DRAWINGS

FIGS. 1A and 1B are diagrams illustrating perspective views of an exemplary embodiment of an accumulator;

FIG. 1C is a diagram illustrating an exploded view of another exemplary embodiment of the accumulator;

FIG. 1D is a diagram illustrating a perspective view of yet another exemplary embodiment of the accumulator;

FIG. 2A is a diagram illustrating an exemplary system that includes an exemplary embodiment of the accumulator;

FIG. 2B is a diagram illustrating another perspective view of the exemplary system that includes an exemplary embodiment of the accumulator;

FIG. 3 is a diagram illustrating an exploded view of elements of the system;

FIG. 4 is a diagram illustrating an exemplary test system that includes an exemplary embodiment of the accumulator; and

FIG. 5 is a diagram illustrating an exemplary process.

### DETAILED DESCRIPTION

The following detailed description refers to the accompanying drawings. The same reference numbers in different drawings may identify the same or similar elements. Also, the following detailed description does not limit the invention.

Meters that measure usage of a resource, such as a utility resource (e.g., water, gas, electricity, etc.) or another type of resource (e.g., chemical, solvent, oil, etc.) are widely used. Further, meters have been combined with electronic components to facilitate communication between the meters and backend systems via a network. For example, a meter interface unit (MIU) may include a transmitter that is configured to wirelessly transmit usage information and other information (e.g., leak information, reverse flow detection, etc.). The MIU may also include a receiver that is configured to wirelessly receive information and commands. The meter and the MIU may be a part of an automated meter reading (AMR) system, such as an AMR system associated with a water utility company, an advanced metering system (AMS), an advanced meter infrastructure (AMI), or another type of architecture associated with a utility company or another entity.

Manufacturers or other entities may subject meters to certain testing for purposes of quality control, calibration, development, and the like. For example, a flow test bench may include an accumulator that assists in flow testing for one or multiple meters. The accumulator may store energy (e.g., pressurized fluid, etc.) for later use. For example, the accumulator may add accumulator flow to a pump flow of a pump included in the flow test bench. The accumulator may be used under other non-testing conditions for other purposes and applications given its storing and supplying properties.

There are different types of accumulators, such as diaphragm type, spring type, and pneumatic type. However, each of these types of accumulators have its own limitations. For example, the diaphragm type accumulator may not allow for large changes in volume, but may be fairly linear in pressure versus volume. The pneumatic type of accumulator may provide for large energy storage and moderate volumes, but requires a good seal and maintenance to prevent leakage. The pneumatic type of accumulator may also exhibit a non-linear response. The spring type accumulator may provide large volume displacement, but also requires a good seal and maintenance to prevent leakage. Accordingly, there is a need in the art to address these limitations and/or deficiencies associated with accumulators.

According to exemplary embodiments, an apparatus is described. According to an exemplary embodiment, the apparatus is an accumulator. For example, the accumulator may include a spring-loaded piston. According to some exemplary embodiments, the accumulator may include a guide rod with a spring. According to some exemplary embodiments, the guide rod may travel in (substantial) unison with the piston. For example, the guide rod may be affixed to the piston. According to an exemplary embodiment, a bumper may be disposed at an end of the guide rod. According to an exemplary embodiment, the bumper may be disposed on the piston. According to other exemplary embodiments, the accumulator may include the spring without the guide rod.

According to an exemplary embodiment, the accumulator may include a baffle and a spacer. According to such an embodiment, the guide rod may be affixed to the baffle and the piston may travel (e.g., slide) through the guide rod towards the baffle with the spring disposed between the piston and the baffle. According to an exemplary embodiment, the baffle may include holes that enable a resource (e.g., fluid, etc.) to travel (e.g., flow) towards an outlet of the accumulator. According to an exemplary embodiment, the accumulator may include an inlet that is configured for a high pressure side of a hydraulic system, and an outlet that is configured for a low pressure side of the hydraulic system.

According to an exemplary embodiment, the accumulator may be configured with a gap that may permit leakage of the resource (e.g., fluid, etc.) past the piston. According to an exemplary embodiment, the gap may be configured to allow a certain amount of leakage that enables filtering of noise, such as pressure fluctuations or pulses of the resource received by the accumulator during its operation, as described herein. For example, the target noise may be of a particular frequency or within a particular frequency band or frequency range. According to another exemplary embodiment, the gap may be configured to allow a certain amount of leakage that enables filtering of a frequency that may relate to a sampling rate of a water meter, such as the sampling rate for measurement of a resource flow. For example, in a hydraulic and test bench system for a water meter, the filtering of the frequency may minimize or prevent interference with the water flow measuring capabilities of the water meter under test.

Additionally, the accumulator may enable any leaked resource to re-enter the hydraulic and test bench system via the outlet such that the leaked resource may operatively be reused, as described herein. According to yet another exemplary embodiment, the gap may be configured to allow a certain amount of leakage that enables filtering of a frequency or a frequency band that may relate to another source (e.g., an upstream device, a downstream device) relative to the accumulator, as described herein.

According to an exemplary embodiment, the piston relative to the inner sleeve of the accumulator may form the gap that enables leakage of the resource. According to an exemplary embodiment, the leakage may be (intentionally) introduced and controlled within the accumulator based on a bypass and control value, as described herein. The accumulator may be tuned for leakage in a manner that beneficially affects the dynamic response and provides smooth flow rates based on a total spring rate and the amount of leakage.

In view of the foregoing, the accumulator may eliminate the use of a sealing element, performance issues associated with poor sealing and its maintenance. Additionally, the accumulator may be tuned for leakage, which may improve the dynamic response of the accumulator, reduce frequency noise, and enable smooth flow rate transitions.

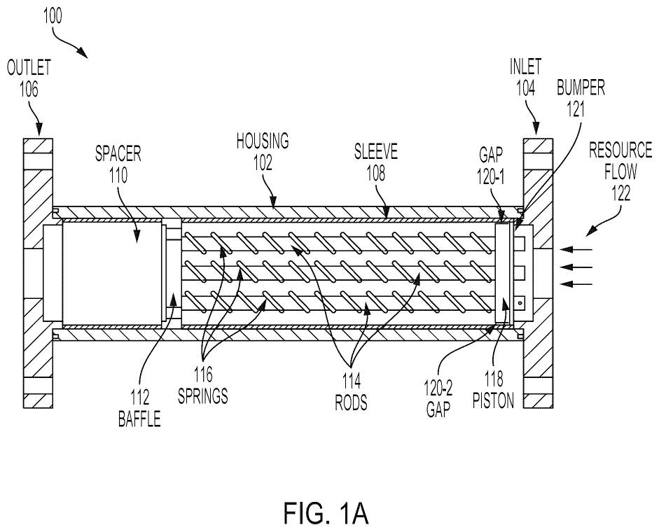

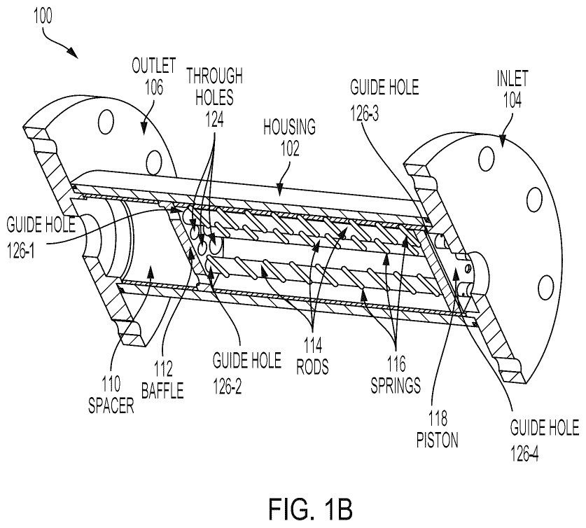

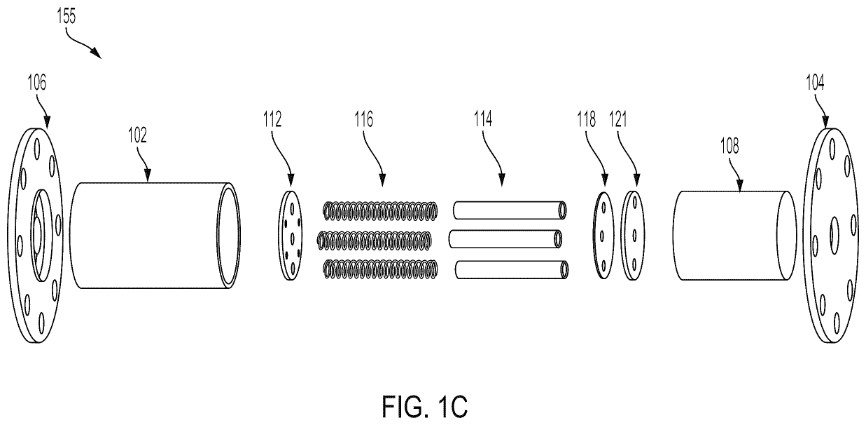

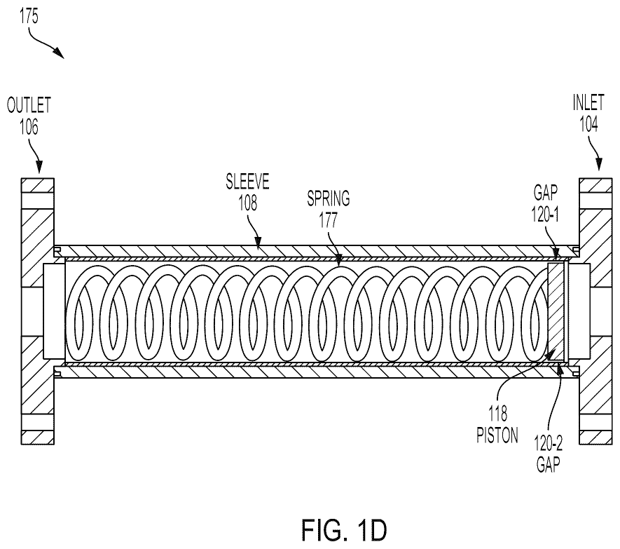

FIG. 1A is a diagram of a perspective view of an exemplary embodiment of an accumulator 100. As illustrated, accumulator 100 may include a housing 102, an inlet 104, an outlet 106, a sleeve 108, a spacer 110, a baffle 112, rods 114, springs 116, a piston 118, and gaps 120-1 and 120-2 (also referred to individually or generally as gap 120). Accumulator 100 is depicted in a state where there is (substantially) equal pressure at inlet 104 and outlet 106 such that piston 118 is disposed at inlet 104 based on springs 116.

According to an exemplary embodiment, an element, a component, or a part (referred to herein simply as an “element”) of accumulator 100 may be made from a metal (e.g., steel, stainless steel, brass, aluminum, a non-corrosive metal, a metal alloy, or the like), a plastic, or a composite, for example. The number of an element illustrated in FIG. 1A is exemplary. For example, FIG. 1A depicts three rods 114. According to other exemplary embodiments, the number of rods 114 may be less than three or greater than three. According to various exemplary embodiments, one or more elements of accumulator 100 may be unitarily formed with one or more other elements, or may be a disparate, separate, or non-unitary elements relative to one or more other elements. For example, housing 102, inlet 104, and outlet 106 may be a unitary element or disparate elements that are assembled.

Housing 102 may be a casing that hosts or encases various elements of accumulator 100. An inner wall of housing 102 may define a chamber that is substantially centrally positioned within housing 102. The chamber may be configured to accommodate other elements of accumulator 100, as described herein.

Inlet 104 and outlet 106 may operate as an input and an output, respectively of accumulator 100, relative to a flow of a resource (e.g., a resource flow 122). For example, the resource may be a physical media, such as a liquid (e.g., water, chemical, etc.) or another type of matter (e.g., gas, etc.). While the direction of resource flow 122 is depicted as entering accumulator 100 via inlet 104, according to other scenarios, resource flow 122 may enter accumulator 100 via outlet 106.

Sleeve 108 may define a passageway between inlet 104 and outlet 106. As illustrated, sleeve 108 may encase rods 114, springs 116, piston 118, and gap 120. Based on pressure at inlet 104, pressure at outlet 106, the area of piston 118, the spring resistance of springs 116, and rods 114 that guide piston 118, piston 118 may move towards baffle 112 within sleeve 108 or move towards inlet 104.

Spacer 110 provides space for rods 114 during operation of accumulator 100. For example, rods 114 may be affixed to piston 118 such that when piston 118 moves toward baffle 112, rods 114 may move through or via holes (not illustrated in FIG. 1A, but illustrated in FIG. 1B as guide holes 126, such as guide holes 126-1 and 126-2) of baffle 112 into a space defined by spacer 110. For example, baffle 112 may include guide hole 126 for each rod 114. Similarly, referring to FIG. 1B, piston 118 may also include guide holes 126, such as 126-3 and 126-4. Piston 118 may include guide hole 126 for each rod 114 that may accommodate the affixation of piston 118 with rod 114. Spacer 110 may have a dimension (e.g., length, diameter, etc.) that may accommodate rods 114 received by spacer 110 when springs 116 are fully compressed and piston 118 may be at a closest distance from baffle 112.

According to another embodiment, rods 114 may be affixed to baffle 112 but not to piston 118, such that piston 118 may move towards baffle 112 along rods 114 as springs 116 compress and while rods 114 are stationary. Thus, rods 114 may not move into the space defined by spacer 110. According to such an embodiment, spacer 110 may be eliminated and baffle 112 may be disposed at outlet 106.

Baffle 112 may be disposed between sleeve 108 and spacer 110. According to an exemplary embodiment, baffle 112 may be implemented as a cylindrical plate. Although not illustrated in FIG. 1A, according to an exemplary embodiment, baffle 112 may include guiding holes 126 (illustrated in FIG. 1B) that enable rods 114 to move from sleeve 108 to spacer 110 and vice versa as piston 118 moves within sleeve 108. According to an exemplary embodiment, baffle 112 may be affixed to rods 114 such that rods 114 may remain stationary as piston 118 may move within sleeve 108. Additionally, although not illustrated in FIG. 1A but shown in FIG. 1B, baffle 112 may include through-holes 124 that enable a resource (e.g., a fluid, etc.) to move from sleeve 108 into spacer 110 and exit accumulator 100 via outlet 106 or to move from outlet 106 into spacer 110, for example. The number, position, and shape of through-holes 124 and guide holes 126 illustrated in FIG. 1B are exemplary. According to various exemplary embodiments, the number and/or shape of through-holes 124 and guide holes 126 may be the same or different. Baffle 112 may be affixed and stationary within housing 102.

Rods 114 may provide support for piston 118 and assist in guiding piston 118 during movement. According to an exemplary embodiment, rods 114 may be cylindrical. As described herein, according to various exemplary embodiments, rods 114 may be affixed to piston 118 or may be affixed to baffle 112. According to some exemplary embodiments, as illustrated in FIG. 1A, rods 114 may protrude through piston 118 towards inlet 104. According to other exemplary embodiments, rods 114 may be flush with the inlet-facing side of piston 118 or may be recessed in piston 118. Similarly, according to some exemplary embodiments, where rods 114 may be affixed to baffle 112, rods 114 may protrude through baffle 112 towards outlet 106, may be flush with the spacer-facing side of baffle 112 or may be recessed in baffle 112. According to some exemplary embodiments, at least some of rods 114 may include bumpers at one end. For example, an embodiment of rods 114 that are affixed to piston 118 and move with piston 118 towards baffle 112, at least some of the ends of rods 114 moving in spacer 110 may include bumpers. The bumpers may be made from a resilient material and reduce impact of the ends of rods 114 on an outlet side wall of spacer 110. According to some exemplary embodiments, the ends of rods 114 with the bumpers or only the bumpers may protrude from the outlet-facing side of baffle 112.

Springs 116 may include a resilient mechanism, such as springs, rings of rubber or another type of resilient material, resilient member, or the like. According to some exemplary embodiments, springs 116 may be implemented as helical springs, compression springs, molded springs, wave springs, or the like. As illustrated in FIG. 1A, springs 116 may surround or retain rods 114. According to some exemplary embodiments, each rod 114 may have a spring 116.

According to other exemplary embodiments, each rod 114 may not have a spring 116. According to still other exemplary embodiments, rod 114 may have multiple springs 116 that may be contiguously disposed along the length of rod 114. At one end, spring 116 may bear against piston 118 and at the other end, spring 116 may bear against baffle 112, which is stationary.

Piston 118 is disposed within sleeve 108 and may be operable to move or reciprocate within sleeve 108. Piston 118 may have a configuration such that a side wall of piston 118 relative to the inner wall of sleeve 108 forms gaps 120. As an example, assume that the inner wall of sleeve 108 is (substantially) cylindrical, piston 118 may also be (substantially) cylindrical such that (a surrounding) gap 120 exists between the side wall of piston 118 and the inner wall of sleeve 108. According to another example, gap 120 may exist between only a portion of the sidewall of piston 118 and inner wall of sleeve 108. According to some exemplary implementations of that example, the sidewall of piston 118 may be configured to form gaps 120 that are symmetrical to one another. For example, one gap 120 (e.g., disposed at the top of piston 118) may have an opposing other gap 120 (e.g., disposed at the bottom of piston 118).

A “loose-fitted” piston 118 may be configured to allow for gap 120 and enable filtering of frequency noise. For example, a range of frequencies may be filtered based on a configured cut-off frequency. By way of further example, the cut-off frequency may be configured to be within a range of about 5 to about 10 Hertz (Hz) in which frequency noise above the cut-off frequency may be filtered (e.g., attenuated, minimized, eliminated, etc.). According to other examples, the cut-off frequency may be different. Additionally, as described herein, piston 118 may be configured for leakage in a manner that beneficially affects the dynamic response of piston 118 and provides for smooth flow rates based on a total spring rate of springs 116, amount of leakage based on gap 120, a flow rate of a resource, a pressure at inlet 104 and/or outlet 106, and/or other factors to which accumulator 100 (including piston 118) may be exposed. Additionally, accumulator 100 may enable any leaked resource to exit accumulator 100 via outlet 106, which may be operatively reused. Thus, as described herein, in contrast to conventional piston-based accumulators, accumulator 100 does not include a seal or similar functioning element that prevents leakage of a resource past piston 118.

As further illustrated, a bumper 121 may be disposed on piston 118. For example, bumper 121 may be disposed on an inlet facing side of piston 118. Bumper 121 may be an elastic element that may mitigate any collision between piston 118 and inlet 104. Referring to FIG. 1B, piston 118 may include guide holes 126.

Gap 120 may be a space disposed between a sidewall of piston 118 and sleeve 108. Gap 120 may enable a resource to propagate from inlet 104 and to further propagate past piston 118 towards baffle 112 (e.g., as a leakage of the resource) or vice versa (e.g., the resource to propagate past piston 118 towards inlet 104. As described herein, the dimension, shape, and/or number of gap 120 may be configured as a frequency noise filtering mechanism, may improve the dynamic response of accumulator 100, and enhance flow rates via accumulator 100.

FIG. 1B is a diagram illustrating another perspective view of accumulator 100. In addition to the elements of accumulator 100 previously illustrated and described in relation to FIG. 1A, FIG. 1B further illustrates through-holes 124, as described herein.

FIG. 1C is a diagram illustrating an exploded view of elements according to an exemplary embodiment of an accumulator 155. In contrast to accumulator 100, accumulator 155 may not include spacer 110. For example, as described herein, rods 114 may be affixed to baffle 112 but not to piston 118, such that piston 118 may move towards baffle 112 along rods 114 as springs 116 compress and while rods 114 are stationary. According to such an embodiment, spacer 110 may be eliminated and baffle 112 may be disposed at outlet 106.

FIG. 1D is a diagram of a perspective view of an exemplary embodiment of an accumulator 175. Like elements of accumulator 175 relative to accumulator 100 will not be described for the sake of brevity. In contrast to accumulator 100 and accumulator 155, accumulator 175 may omit rod 114. Additionally, according to some exemplary embodiments of accumulator 100, baffle 112 may be omitted. For example, according to an exemplary embodiment, accumulator 175 may include a spring 177. According to some exemplary embodiments, spring 177 may be implemented as a single spring that has a dimension corresponding to sleeve 108. Despite these distinctions, piston 118 may move within sleeve 108 in a manner similar to that described herein, and gap 120 may permit leakage of a resource.

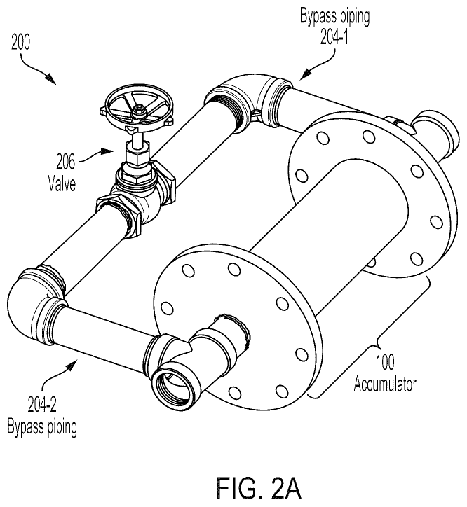

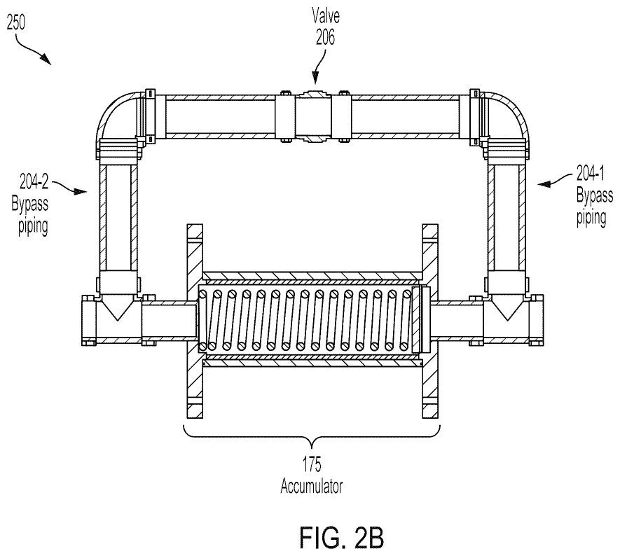

FIG. 2A is a diagram illustrating a perspective view of a system 200 that includes an accumulator. As illustrated, system 200 may include an embodiment of the accumulator, such as accumulator 100 or another embodiment of the accumulator (e.g., accumulator 155, accumulator 175, etc.). Additionally, system 200 may further include a bypass, which may include bypass piping 204-1 and 204-2 (also referred to collectively as bypass piping 204 and individually or generally as bypass piping 204) and a valve 206.

Bypass piping 204 may enable a resource flow to bypass accumulator 100. The diameter of bypass piping 204 may be commensurate with inlet 104 and outlet 106 of the accumulator or another size that provides a threshold level of inductance as an electric analogue associated with the movement of piston 118 of accumulator 100. For example, substantial changes in pressure of the resource may negatively impact the dynamic response of accumulator 100 and contribute to noise. However, bypass piping 204 and valve 206 may enable a tunable leakage and associated dynamic response, filtering of frequency noise, and a desired flow rate, as described herein. The length of bypass piping 204 may also be a consideration in which a threshold value of resistance as an electric analogue may be attributed to the flow of the resource via the bypass.

Valve 206 may include a device that regulates the flow of a resource, such as a fluid (e.g., water, etc.) or another type of matter via bypass piping 204. For example, valve 206 may be implemented as a manual valve, an actuated value (e.g., connected to an actuator, not illustrated), an automatic valve (e.g., activated when a specific flow condition is met), a ball valve, or another type of valve. Although not illustrated, according to another example, valve 206 may be implemented as an orifice plate. Valve 206 may regulate the flow and pressure of the resource that may bypass accumulator 100 while enabling sufficient flow and pressure of the resource through accumulator 100. FIG. 2B is a diagram illustrating a perspective view of a system 250 that includes bypass piping 204, valve 206, and accumulator 175. For example, FIG. 2B may show an orthogonal section view of system 250.

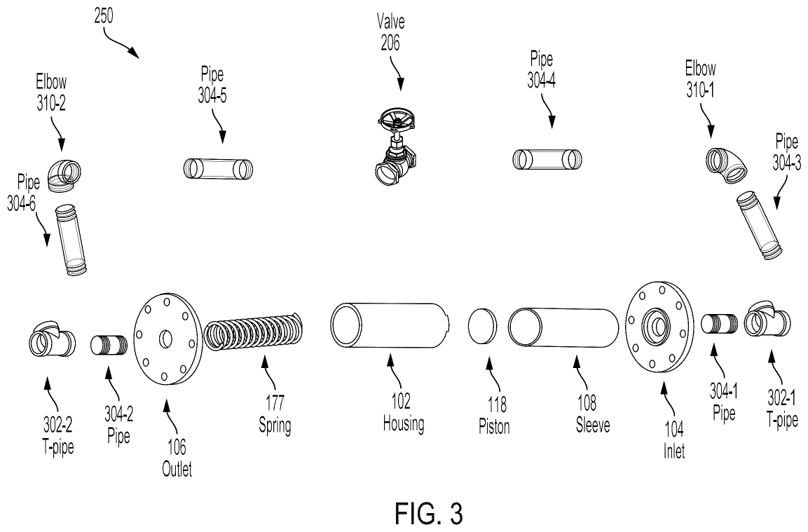

FIG. 3 is a diagram illustrating an exploded view of system 250. For example, bypass piping 204 may include T-pipes 302-1 and 302-2, straight pipes 304-1 through 304-6, and elbows 310-1 and 310-2, as well as other elements previously described, such as valve 206, and those of accumulator 100, such as inlet 104, outlet 106, housing 102, sleeve 108, piston 118, and spring 177.

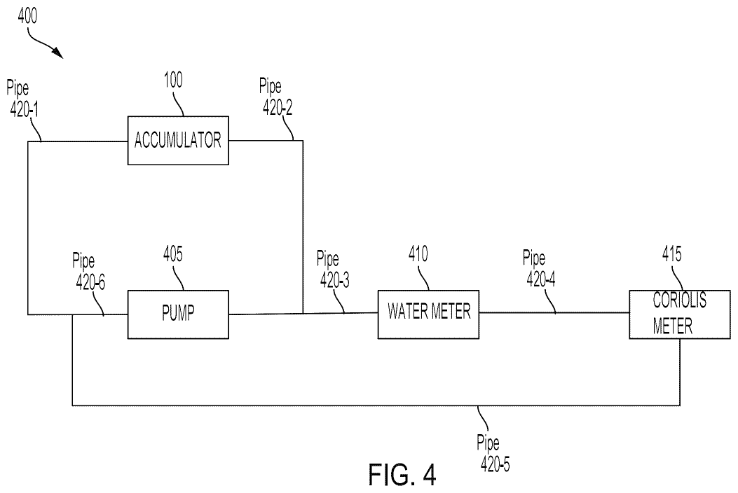

FIG. 4 is a diagram illustrating an exemplary test system 400. For example, test system 400 may be implemented as a flow test bench. As illustrated, system 400 may include accumulator 100 (or another embodiment of the accumulator), a pump 405, a water meter 410, and a Coriolis meter 415. Accumulator 100, pump 405, water meter 410, and Coriolis meter 415 may be interconnected using piping, such as pipes 420-1 through 420-6. As an example, pipe 420-1 may be connected to outlet 106 of accumulator 100 and pipe 420-2 may be connected to inlet 104 of accumulator 100. The number of elements of system 400 is exemplary. For example, system 400 may test one or multiple water meters 410. Additionally, system 400 may include one or multiple Coriolis meters 415. According to other embodiments, a device other than water meter 410 may be tested and/or system 400 may not include a reference meter, such as Coriolis meter 415, or a reference device other than Coriolis meter 415 may be used.

Pump 405 may include a device that regulates pressure and flow of the resource, such as water. Water meter 410 may include a device that measures water usage, among other functions. For example, water meter 410 may be implemented as an ultrasonic water meter or another type of water meter. Coriolis meter 415 may measure the mass flow rate of the resource, such as water. Coriolis meter 415 may measure other variables, such as temperature, density, etc.

According to some exemplary embodiments, although not illustrated, system 400 may include the bypass (e.g., bypass piping 204) and valve (e.g., valve 206) depicted and described in relation to FIGS. 2A, 2B, or 3. According to some exemplary embodiments, the tuning of the bypass may be directed to the sampling rate of water meter 410. For example, the bypass may notch a frequency of the sampling rate for measuring by water meter 410. By way of further example, the frequency may be implemented around 25 Hz or another configurable frequency. As another example, the frequency may be implemented about 10 Hz, about 20 Hz, or a frequency band, such as about 10 Hz and higher, about 20 Hz and higher, about 25 Hz and higher, and so forth. The bypass may prevent or mitigate damage to pump 405 and control the amount of leakage, as described herein. In a hydraulic system, oscillatory noise may interfere with the accuracy of water meter flow measurements by water meter 410 under test, and the bypass may smooth out the flow downstream from accumulator 100 and improve accuracy of downstream measurements.

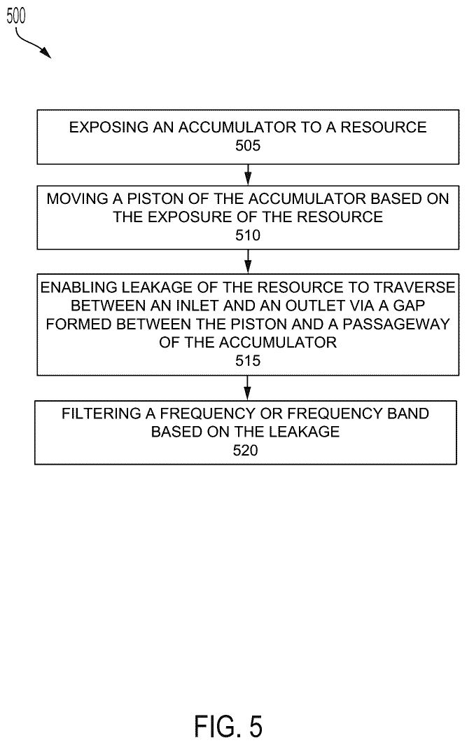

FIG. 5 is a diagram illustrating an exemplary process 500 pertaining to an exemplary embodiment of the accumulator, as described herein.

In block 505, the accumulator may be exposed to a resource. For example, the accumulator may be exposed to a fluid or other type of resource at inlet 104 and outlet 106. The accumulator may receive the resource via inlet 104 or outlet 106, for example, to which the accumulator is exposed. According to some exemplary scenarios, the accumulator may be included in a hydraulic system in which the inlet 104 is connected to a high pressure side of the hydraulic system and outlet 106 is connected to a low pressure side of the hydraulic system.

In block 510, a piston of the accumulator may move within a passageway based on the exposure to the resource. For example, piston 118 may move within sleeve 108 of the accumulator based on the exposure of the resource and differences in pressure at inlet 104 and outlet 106.

In block 515, leakage of the resource may traverse between the inlet and the outlet of the accumulator based on a gap formed between the piston and the passageway. For example, gap 120 may be configured to enable an amount of leakage of the resource past piston 118, as described herein.

In block 520, a frequency or frequency band may be filtered based on the leakage. For example, a single frequency or a range of frequencies (e.g., frequency X through frequency Y) may be filtered based on the dimension of gap 120 and the amount of leakage. According to one example, gap 120 may be configured to filter a frequency band of noise during its operation based on the amount of the leakage of the resource via gap 120. According to another example, gap 120 may be configured to filter a frequency during its operation based on an amount of the leakage of the resource via gap 120, where the frequency corresponds to a sampling rate of a water meter (e.g., water meter 410), a pump (e.g., pump 405), or another upstream or downstream device. By way of further example, the accumulator may be used in a test bench system (e.g., test system 400).

A system may exhibit a sensitivity to a frequency or a frequency band (e.g., range of frequencies (X frequency-Y frequency)) in which a noise may inhibit the functioning of the system. For example, a pump, such as pump 405 or another type of pump, may introduce pressure fluctuations into a resource contained in a pipe and those pressure fluctuations may be characterized by the frequency or the frequency band. According to another example, a measurement device, such as a meter 410 or another type of measurement device, may measure a resource at a sampling rate, and the variation of the measurement may be increased if the frequency or the frequency band of noise is concurrent with the sampling rate of the measurement device. According to yet another example, a control value may introduce pressure pulses into a resource, such as water hammer. According to still another example, a load device, such as a hydraulic motor or a pneumatic motor may introduce pressure fluctuations into a resource, and those pressure fluctuations may be characterized by the frequency or frequency band.

There are additional examples in which the filtering of noise may be beneficial. For example, an unmodified system may exhibit a resonant frequency, excitation of which may damage the system or inhibit its intended function, and that resonant frequency may be concurrent with the frequency or the frequency band. A system may embody any combination of these examples sequentially or simultaneously. According to such circumstances, at least one accumulator, as described herein, may be employed to modify the dynamics of the system, in part or in whole, so as to filter (e.g., attenuate, eliminate, etc.) the frequency or the frequency band, noise, etc., and improve the functioning of the system. This process may be beneficial to other devices upstream and/or downstream from the accumulator. As an example, the flow rate at the output of the accumulator may be unresponsive at a frequency or a frequency band to the pressure fluctuations at the inlet of the accumulator. As a consequence, the flow rate may be relatively constant despite the pressure fluctuations that may be occurring in the system including the accumulator.

As set forth in this description and illustrated by the drawings, reference is made to “an exemplary embodiment,” “an embodiment,” “embodiments,” etc., which may include a particular feature, structure, or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Spatially relative terms, such as “beneath,” “below,” “lower,” “above,” “upper,” “top”, “bottom” and the like, may be used herein for ease of description to describe one element's or feature's relationship to another element or feature as illustrated in the figures. The spatially relative terms are intended to encompass different orientations of the device in use or operation, in addition to the use or the operation depicted in the figures. For example, if the device in the figure is turned over, an element described as “below” or “beneath” another element or another feature would then be oriented “above” the other element or the other feature. Thus, the exemplary terms “below” or “beneath” may encompass both an orientation of above and below depending on the orientation of the device. In the instance that the device may be oriented in a different manner (e.g., rotated at 90 degrees or at some other orientation), the spatially relative terms used herein should be interpreted accordingly.

When an element is referred to as being “on” or “over” another element, the element can be directly on the other element or an intervening element may also be present. In contrast, when an element is referred to as being “directly on” or “directly over” another element, there is no intervening element present. When an element is referred to as being “connected” or “coupled” to another element, the element can be directly connected or coupled to the other element. In contrast, when an element is referred to as being “directly connected” or “directly coupled” to another element, there is no intervening element present.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated. The term “substantially” is used herein to represent the inherent degree of uncertainty that may be attributed to any quantitative comparison, value, measurement, or other representation. The term “substantially” is also used herein to represent the degree by which a quantitative representation may vary from a stated reference without resulting in a change in the basic function of the subject matter at issue.

No element, act, or instruction set forth in this description should be construed as critical or essential to the embodiments described herein unless explicitly indicated as such.

All structural and functional equivalents to the elements of the various aspects set forth in this disclosure that are known or later come to be known to those of ordinary skill in the art are expressly incorporated herein by reference and are intended to be encompassed by the claims.

What is claimed is:

1. An accumulator comprising:
an inlet;
an outlet;
a passageway between the inlet and the outlet;
a piston disposed in the passageway between the inlet and the outlet; and
a resilient member disposed between the outlet and a first side of the piston facing the outlet, wherein a gap between a side of the passageway and a second side of the piston facing the side of the passageway allows a leakage of a medium.

2. The accumulator of claim 1, wherein the gap is configured to filter a frequency band of noise caused by an upstream device or a downstream device relative to the accumulator based on an amount of the leakage of the medium.

3. The accumulator of claim 1, wherein the gap is configured to filter a frequency during operation based on an amount of the leakage of the medium, wherein the frequency corresponds to a sampling rate of a water meter.

4. The accumulator of claim 1, further comprising:
a baffle, wherein the baffle is disposed between the piston and the outlet and includes one or more through-holes; and
a rod, wherein the rod and the resilient member are disposed between the baffle and the piston, and wherein the resilient member surrounds the rod.

5. The accumulator of claim 4, wherein the rod is affixed to the baffle but not the piston, allowing the piston to move along a length of the rod via a guide hole of the piston.

6. The accumulator of claim 5, wherein a bumper member is disposed on a third side of the piston facing the inlet.

7. The accumulator of claim 4, wherein the rod is affixed to the piston but not the baffle, allowing the piston and the rod to move together, and wherein the rod moves through a guide hole of the baffle.

8. The accumulator of claim 7, wherein a bumper member is disposed at an end of the rod.

9. The accumulator of claim 1, wherein the medium is water.

10. The accumulator of claim 1, wherein the resilient member is a spring.

11. A method comprising:
exposing an accumulator to a medium, wherein the accumulator comprises an inlet, an outlet, a passageway between the inlet and the outlet, and a resilient member disposed between the outlet and a first side of a piston facing the outlet;
moving the piston disposed within the passageway based on a difference of pressure of the medium at the inlet and the outlet; and
enabling leakage of the medium to traverse between the inlet and the outlet via a gap of the accumulator that is formed between a side of the passageway and a second side of the piston facing the side of the passageway.

12. The method of claim 11, wherein the gap is configured to filter a frequency band of noise caused by an upstream device or a downstream device relative to the accumulator based on an amount of the leakage of the medium.

13. The method of claim 11, wherein the gap is configured to filter a frequency during operation based on an amount of the leakage of the medium, wherein the frequency corresponds to a sampling rate of a water meter.

14. The method of claim 11, wherein the accumulator further comprises:
a baffle, wherein the baffle is disposed between the piston and the outlet and includes one or more through-holes; and
a rod, wherein the rod and the resilient member are disposed between the baffle and the piston, and wherein the resilient member surrounds the rod.

15. The method of claim 14, wherein the rod is affixed to the baffle but not the piston, allowing the piston to move along a length of the rod via a guide hole of the piston.

16. The method of claim 15, wherein a bumper member is disposed on a third side of the piston facing the inlet.

17. The method of claim 14, wherein the rod is affixed to the piston but not the baffle, allowing the piston and the rod to move together, and wherein the rod moves through a guide hole of the baffle.

18. The method of claim 11, wherein the medium is water.

19. The method of claim 11, wherein the resilient member is a spring.

20. An apparatus comprising:
an inlet;
an outlet;
a passageway between the inlet and the outlet;
a piston disposed in the passageway between the inlet and the outlet; and
a resilient member disposed between the outlet and a first side of the piston facing the outlet, wherein a gap between a side of the passageway and a second side of the piston facing the side of the passageway allows a leakage of a medium.
